(19) United States
(12) Patent Application Publication
(10) Pub. No.: US 2015/0258698 A1
(43) Pub. Date: Sep. 17, 2015

(54) Manufacture of Potato Chips

(71) Applicants: Brian Butt, Lincolnshire (GB); Chris De Bruyne, Veurne (BE); Ahmed Nadim Khan, Staffordshire (GB); Neal Lingard, Leicestershire (GB); Joe McDonnell, Leicestershire (GB); John O'Brien, Leicester (GB); Nico Vandecasteele, Veurne (BE)

(72) Inventors: Brian Butt, Lincolnshire (GB); Chris De Bruyne, Veurne (BE); Ahmed Nadim Khan, Staffordshire (GB); Neal Lingard, Leicestershire (GB); Joe McDonnell, Leicestershire (GB); John O'Brien, Leicester (GB); Nico Vandecasteele, Veurne (BE)

(21) Appl. No.: 14/432,125

(22) PCT Filed: Mar. 12, 2013
(86) PCT No.: PCT/EP2013/054930

§ 371 Date: Mar. 27, 2015

(30) Foreign Application Priority Data
Sep. 28, 2012 (GB) 1217414.0

(51) Int. Cl. B26D 1/03; A23L 1/217; B26D 7/26; B26D 1/00; B26D 7/06

(52) U.S. Cl. CPC B26D 1/03; B26D 1/0006; B26D 7/0691; B26D 7/2614; A23L 1/217; B26D 2001/004; B26D 2210/02; A23V 2002/00

(57) ABSTRACT

A potato chip cutting apparatus, the apparatus comprising an annular-shaped cutting head and a central impeller coaxially mounted for rotation within the cutting head for delivering potatoes radially outwardly toward the cutting head, the impeller having a base with an upper surface across which potatoes are, in use, delivered to the cutting head, a plurality of knives serially mounted annularly around the cutting head, each knife having a first cutting edge extending substantially vertically and spaced from the cutting head to provide a gap between the first cutting edge and the cutting head, each knife also having a second cutting edge extending substantially horizontally and extending radially at least partly across the gap, the second cutting edge being located at least 50 mm above the upper surface of the impeller to define a cutting zone for cutting a single potato slice between the upper surface and the second cutting edge.

### CROSS-REFERENCE TO RELATED APPLICATIONS

This application is a 371 National Stage Application claiming priority to PCT Application No. PCT/EP2013/054930 filed Mar. 12, 2013, which claims priority to Great Britain Application No. 1217414.0 filed Sep. 28, 2012, now GB Patent No. 2506420 issued Aug. 27, 2014, the technical disclosures of which are hereby incorporated by reference.

### BACKGROUND TO THE INVENTION

The present invention relates to a potato slice cutting head and to a method of producing potato chips using a potato slice cutting head.

### DESCRIPTION OF THE PRIOR ART

It is well known to employ a rotary cutting apparatus for cutting potatoes into fine slices for the manufacture of potato chips. A well-known cutting apparatus, which has been used for more than 50 years, comprises an annular-shaped cutting head and a central impeller assembly coaxially mounted for rotation within the cutting head to deliver food products, such as potatoes, radially outwardly toward the cutting head.

A series of knives is mounted annularly around the cutting head and the knife cutting edges extend substantially circumferentially but slightly radially inwardly towards the impeller assembly. Each knife blade is clamped to the cutting head to provide a gap, extending in a radial direction, between the cutting edge of the blade and the head. The gap defines the thickness of the potato slices formed by the cutter.

In the manufacture of potato chips, the potatoes are cut into slices and, after cooking, for example by frying, and seasoning potato chips are produced which then are packaged for the consumer.

One problem with current manufacturing methods and apparatus is that sometime a small proportion of the potato chips have a maximum width dimension that the potato chips can be difficult to package. Typically, a measured amount of the potato chips is filled into a package which comprises a flexible bag, of selected dimensions, for packaging a defined weight of the potato chips. The bag is filed by, for example, a known vertical form, fill and seal (VFFS) machine. During the filling step, the package has an upper opening presenting a maximum width dimension, most typically a diameter of the opening, through which the potato chips are filled downwardly into the bag under gravity.

If the potato chips are too large in dimension, it is difficulty to fill the bag reliably and at high speed. Intermittently, some of the potato chips may inadvertently become tapped in the upper seal of the bag, which compromises product quality. In some cases, up to about 0.5% of the packages can be wasted because of this phenomenon. In addition, consumers may purchase faulty packaged products, which may lead to undesired consumer complaints.

Furthermore, large potato slices can reduce the ability of a given weight of potato chips to pack together in a package. This can require the packaging line speed to be reduced, which increases the production costs and lowers the production efficiency. Additionally, the package volume needs to be enlarged to be able to accommodate the poor chip packing density.

In order to attempt to alleviate the problems of excessively large potato chips, it is known to use grade potatoes prior to processing in order to ensure that the potatoes are sufficiently small that these packaging problems are minimized. The grading may be manual or automated. However, the use of small potatoes reduces the productivity and efficiency of the potato chip manufacturing process. Also, the production line cost is increased.

Also, there is an increasing desire to use large potatoes to manufacture potato chips in order to increase the productivity and efficiency of the potato chip manufacturing process. Large potatoes are agronomically more productive with a higher yield per acre of crops. There are some potato varieties which are used to manufacture other potato products, such as French fries, but which cannot efficiently be used to manufacture potato chips using known potato chip manufacturing apparatus and processes because the potatoes are too large.

If potatoes are used which are too large for the cutting head to process, it is known to use a “grader halver” upstream of the potato slicer. The grader halver cuts the potatoes in half prior to slicing in order to reduce the slice dimensions. There are a number of problems with the use of potato halvers. First, the production line cost is increased. Second, the grader halvers are not very efficient and can reduce production speeds. Third, the presence of potato chips with straight edges in a package of potato chips is generally not acceptable to the consumer.

It is also known to use packaging machines with “chip breakers” which remove or break up excessively large potato chips immediately upstream of the packaging machine. However, this causes product waste and/or can also produce a large number of crumbs or small pieces which again are generally not acceptable to the consumer.

### SUMMARY OF THE INVENTION

The present invention aims at least partially to overcome at least some of these problems of the known methods and apparatus for manufacturing potato slices and potato chips made therefrom.

Accordingly, the present invention provides an apparatus for cutting potato slices, the apparatus comprising an annular-shaped cutting head and a central impeller coaxially mounted for rotation within the cutting head for delivering potatoes radially outwardly toward the cutting head, the impeller having a base with an upper surface across which potatoes are, in use, delivered to the cutting head, a plurality of knives serially mounted annularly around the cutting head, each knife having a first cutting edge extending substantially vertically and spaced from the cutting head to provide a gap, extending in a radial direction, between the first cutting edge and the cutting head, each knife also having a second cutting edge extending substantially horizontally and extending radially at least partly across the gap, the second cutting edge being located at least 50 mm above the upper surface of the impeller to define a cutting zone for cutting a single potato slice between the upper surface of the impeller and the second cutting edge.

Optionally, the second cutting edge is located from 60 mm to 90 mm above the upper surface of the impeller. Further optionally, the second cutting edge is located from 70 mm to 80 mm above the upper surface of the impeller.

Optionally, the second cutting edge is orthogonal to the first cutting edge.

Optionally, the second cutting edge is located rearwardly of the first cutting edge, typically by a distance of at least 1 mm, more typically from 4 to 10 mm, typically about 8 mm.

Optionally, in each knife the first and second cutting edges are formed on respective first and second knife elements.

Typically, the first knife element comprises an elongate substantially planar blade removably clamped to the cutting head by an elongate clamping member mounted adjacent to the first knife element.

Typically, the second knife element comprises a blade portion extending substantially orthogonally from a base portion, the base portion being removably clamped to the cutting head by the elongate clamping member.

Optionally, the base portion is removably clamped against the first knife element.

In some preferred embodiments, the elongate clamping member includes a slot through which extends the blade portion of the second knife element.

Optionally, the slot is a closed slot located rearwardly of a leading edge of the elongate clamping member.

In some preferred embodiments, the elongate clamping member includes at least two slots spaced apart in a longitudinal direction along the elongate clamping member, each slot being provided for mounting the second knife element at a respective predetermined distance from the upper surface of the impeller. Alternatively, in other embodiments there is a single slot in the clamping member.

The present invention further provides a method of producing potato slices for the manufacture of potato chips, the method comprising the steps of:
a. providing a plurality of potatoes;
b. feeding the potatoes to a cutting head adapted to cut the potatoes into slices, the cutting head having a plurality of knives;
c. delivering each potato to a respective knife in the cutting head, the knife having a first cutting edge adapted to cut the potato into slices and a second cutting edge adapted to cut any potato slice having a width greater than a predetermined dimension into two slice portions, the two slice portions comprising a first slice portion having a first maximum width corresponding to the predetermined dimension and a second slice portion having a second maximum width smaller than the first maximum width;
d. cutting each potato into a plurality of slices by the first cutting edge; and
e. cutting each slice having a width greater than the predetermined dimension into the first and second slice portions by the second cutting edge.

Optionally, in step b the potatoes fed to the cutting head are initially uncut.

Optionally, the predetermined dimension is at least 50 mm, further optionally from 60 mm to 90 mm, yet further optionally from 70 mm to 80 mm.

Typically, cutting steps d and e are carried out substantially simultaneously.

Preferably, cutting step e cuts the slice into only two slice portions.

Optionally, the plurality of potatoes provided in step a has a median potato diameter and the predetermined distance is greater than the median potato diameter so that at least 50%, further optionally at least 60%, of the slices produced after cutting steps d and e are uncut in step e.

Optionally, the cutting head is an annular-shaped cutting head and a central impeller is coaxially mounted for rotation within the cutting head for delivering potatoes radially outwardly toward the cutting head.

Optionally, the impeller has a base with an upper surface across which potatoes are, in use, delivered to the cutting head, and the knives are serially mounted annularly around the cutting head.

Optionally, each first cutting edge extends substantially vertically and is spaced from the cutting head to provide a gap, extending in a radial direction, between the first cutting edge and the cutting head, each second cutting edge extending substantially horizontally and extending radially at least partly across the gap.

Optionally, each second cutting edge is located at least 50 mm above the upper surface of the impeller to define a cutting zone for cutting a single potato slice between the upper surface of the impeller and the second cutting edge

The present invention further provides a method of manufacturing potato chips, the method comprising the steps of:
i. providing a plurality of potato slices produced by the method of the invention;
ii. cooking and seasoning the potato slices to produce flavored potato chips; and
iii. filling a measured amount of the potato chips into a package, wherein during the filling step the package has an opening presenting a maximum width dimension, and the potato chips have a maximum width which is no more than 90% of the maximum width dimension of the opening.

Typically, the potato chips have a maximum width which is no more than 80% of the maximum width dimension of the opening.

The present invention further provides a method of manufacturing potato chips, the method including the steps of:
a. providing a plurality of uncut potatoes which have been graded to provide a potato diameter distribution having a median potato diameter;
b. feeding the uncut potatoes to a cutting head adapted to cut the potatoes into slices;
c. in the cutting head cutting each potato into a plurality of slices; and
d. in the cutting head cutting each slice having a width greater than at least the median potato diameter into first and second slice portions so that at least 50% of the slices produced after cutting steps c and d are uncut in step d.

Typically, cutting steps c and d are carried out so that at least 60% of the slices produced after cutting steps c and d are uncut in step d.

Optionally, in cutting step d each slice having a width greater than 70 mm, or 60 mm, or 50 mm, is cut into first and second slice portions.

Optionally, cutting steps c and d are carried out substantially simultaneously.

Optionally, cutting step d cuts the slice into only two slice portions.

Optionally, the cutting head is an annular-shaped cutting head and a central impeller is coaxially mounted for rotation within the cutting head for delivering potatoes radially outwardly toward the cutting head.

Optionally, the impeller has a base with an upper surface across which potatoes are, in use, delivered to the cutting head.

Optionally, the cutting head has a plurality of knives serially mounted annularly around the cutting head, each knife having a first cutting edge cutting the slices in step c and a second cutting edge cutting the slices in step d.

Optionally, each first cutting edge extends substantially vertically and is spaced from the cutting head to provide a gap, extending in a radial direction, between the first cutting edge and the cutting head, each second cutting edge extending substantially horizontally and extending radially at least partly across the gap.

Optionally, wherein each second cutting edge is located at least 50 mm above the upper surface of the impeller to define a cutting zone for cutting a single potato slice between the upper surface of the impeller and the second cutting edge.

Typically, the method further comprises the step of:
e. cooking and seasoning the potato slices from cutting steps c and d to produce flavored potato chips; and
f. filling a measured amount of the potato chips into a package, wherein during the filling step the package has an opening presenting a maximum width dimension, and the potato chips have a maximum width which is no more than 90% of the maximum width dimension of the opening.

Optionally, the potato chips have a maximum width which is no more than 80% of the maximum width dimension of the opening.

The preferred embodiments of the present invention provide a number of technical and commercial advantages and benefits over the known methods and apparatus for manufacturing potato slices and potato chips made therefrom.

First, the potato chips have a controlled maximum width dimension so that the potato chips are easier to package, particularly into flexible bags by use of a known vertical form, fill and seal (VFFS) machine. The bag can be filed reliably and at high speed. Packaging waste and consumer complaints can be reduced.

The packaging line speed can be high, which reduces the production costs and increases the production efficiency. There is very little additional capital cost or running cost by the introduction of the modified twin blade assembly used in the embodiments of the present invention.

Additionally, the package volume can be reduced for a given weight of product because of the increased chip packing density.

Furthermore, the upstream grading of potatoes prior to processing can be reduced or eliminated. There is no need to use grader halvers. The production line capital and running costs can be reduced.

Also, large potatoes can be used to manufacture potato chips in order to increase the productivity and efficiency of the potato chip manufacturing process. Some potato varieties which have not hitherto been used commercially in large volumes to manufacture potato chips efficiently can now be used to manufacture potato chips.

By controlling the dimensional location of the second cutting edge relative to the dimensions of the incoming potato population to be processed, an effective and efficient apparatus and process are provided which allow large potatoes to be used while minimizing the proportion of potato chips with straight edges in a package of potato chips. Also, “chip breakers” can be avoided, and product waste and/or excessive crumbs or small pieces can be minimized.

### BRIEF DESCRIPTION OF THE DRAWINGS

Embodiments of the present invention will now be described, by way of example only, with reference to the accompanying drawings, in which:

FIG. 1 is a schematic side view of a cutting head of a potato slice cutting apparatus in accordance with an embodiment of the present invention;

FIG. 2 is a schematic side view of the cutting head of FIG. 1 when used to cut potato slices showing the cutting operation on two differently sized potatoes;

FIG. 3 is an exploded schematic perspective view of a knife assembly in the cutting head of FIG. 1;

FIG. 4 is a schematic perspective view of the knife assembly in the cutting head of FIG. 1; and

FIG. 5 is a schematic process flow chart which illustrates sequential steps during manufacture of potato chips in accordance with another aspect of the present invention.

### DETAILED DESCRIPTION OF THE PREFERRED EMBODIMENTS

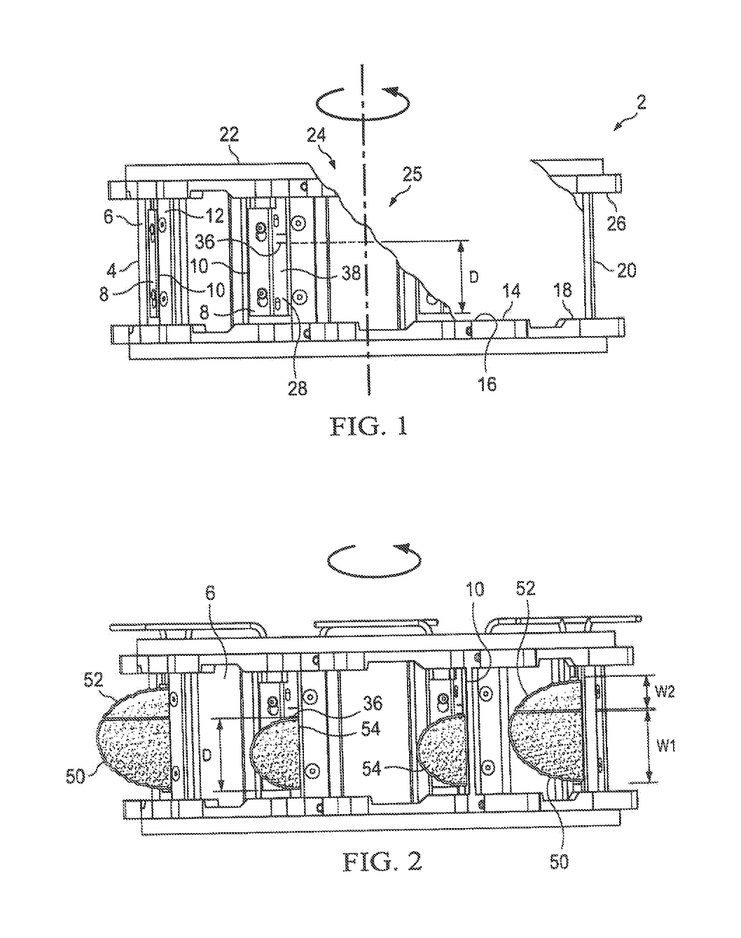

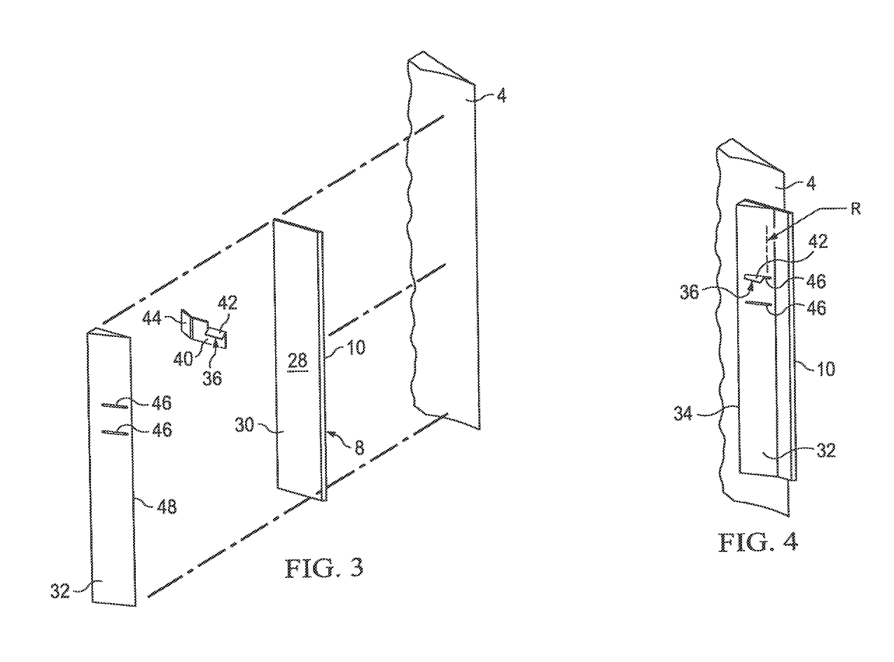

Referring to FIGS. 1 to 4, a potato slice cutting apparatus 2 in accordance with an embodiment of the present invention comprises an annular-shaped cutting head 4. The cutting head 4 includes a cylindrical wall 6 in which a plurality of knives 8 are serially mounted annularly around the cutting head 4. The knife cutting edges 10 extend substantially circumferentially but slightly radially inwardly. Each knife 8 has a first cutting edge 10 extending substantially vertically. The knife first cutting edges 10 extend substantially circumferentially but slightly radially inwardly. Each knife first cutting edge 10 is spaced from the cutting head 4 to provide a respective gap 12, extending in a substantially radial direction, between the first cutting edge 10 and the cutting head 4. The gap 12 defines a slice thickness to be cut by the potato chip cutting apparatus 2.

A central impeller 14 is coaxially mounted for rotation within the cutting head 4 for delivering potatoes radially outwardly toward the cutting head 4. The impeller 14 has a base 16 with an upper surface 18 across which potatoes are, in use, delivered to the cutting head 4. The base 16 is spaced from the lower edge 20 of the cylindrical wall 6. A cover 22 having a potato supply opening 24 is fitted to the upper edge 26 of the cylindrical wall 6. The cylindrical wall 6, base 16 and cover 22 define a central cavity 25.

The first cutting edge 10 is formed on a first knife element 28. The first knife element 28 comprises an elongate substantially planar blade element 30 removably and adjustably clamped to the cutting head 4 by an elongate clamping member 32 of a blade mount 34 adjacent to the first knife element 28. The exposed first cutting edge 10 points substantially circumferentially but is oriented radially inwardly, as is known in the potato chip cutter art. The width of the gap 12 can be varied by moving the first knife element 28 in the blade mount 34.

Each knife 8 also has a second cutting edge 36 extending substantially horizontally and extending radially at least partly across the gap 12. The second cutting edge 36 is located a predetermined distance D which is at least 50 mm above the upper surface 18 of the impeller 14 to define a cutting zone 38 for cutting a single potato slice between the upper surface 18 of the impeller 14 and the second cutting edge 36.

Optionally, the second cutting edge 36 is located from 60 mm to 90 mm, typically from 70 mm to 80 mm, above the upper surface 18 of the impeller 14.

The second cutting edge 36 is preferably orthogonal to the first cutting edge 10; for example the first cutting edge 10 is vertically oriented and the second cutting edge 36 is oriented horizontally. The second cutting edge 36 is preferably located rearwardly of the first cutting edge 10, typically by a distance R of at least 1 mm, optionally from 4 to 10 mm, typically about 8 mm. The second cutting edge 36 may extend parallel to the first cutting edge 10 or be inclined so as to extend rearwardly from second cutting edge 36.

The second cutting edge 36 is formed on a respective second knife element 40. The second knife element 40 comprises a blade portion 42 extending substantially orthogonally from a base portion 44. The base portion 44 is adjustably and removably clamped to the cutting head 4 by the elongate clamping member 32. In particular, the base portion 44 is removably clamped against the first knife element 28. The blade portion 42 of the second knife element 40 is preferably orthogonal to the first knife element 28; for example the first knife element 28 is vertically oriented and the blade portion 42 of the second knife element 40 is oriented horizontally.

The elongate clamping member 32 includes a slot 46 through which extends the blade portion 42 of the second knife element 40. The slot 46 is a closed slot located rearwardly of a leading edge 48 of the elongate clamping member 32. In a particular embodiment, as illustrated, the elongate clamping member 32 includes at least two slots 46 spaced apart in a longitudinal direction along the elongate clamping member 32, each slot 46 being provided for mounting the second knife element 40 at a respective predetermined distance D from the upper surface 18 of the impeller 14. Alternatively, in other embodiments there is a single slot 46 in the clamping member 32 for mounting the blade portion 42 at a respective longitudinal position along the length of the clamping member 32.

In the illustrated embodiment, the knife 8 comprises a multiple knife assembly, with the first knife element 28 and the second knife element 40 being independent and separable. When two separable knife elements 28, 40 are provided in each knife 8, the individual knife elements 28, 40 can be independently replaced when the respective blade become worn. Also, as disclosed above, the second knife element 40 can be selectively moved relative to the first knife element 28, in particular in the longitudinal direction of the first knife element 28, in order to vary the distance D without moving the first knife element 28.

In an alternative embodiment, the knife comprises a single knife assembly element, with the first knife element 28 and the second knife element 40 being bonded together, for example by welding, or unitary and integral.

Typically, the first knife element 28 and the second knife element 40 are composed of stainless steel.

In use, whole potatoes, typically previously uncut, to be sliced by the potato chip cutting apparatus 2 for the manufacture of potato chips are supplied into the central cavity 25. The potatoes are urged radially outwardly by the impeller 14 under the action of a centrifugal force and are individually retained against the inner cylindrical surface of the impeller 14. The radially outward surface of the potato is cut by the first cutting edge 10 of the knives 8 which rotate, together with the impeller 14 holding the potatoes, within the cylindrical wall 6 of the cutting head 4. This motion causes individual slices 54 sequentially to be cut from the potato by the serially mounted knives 8. Each slice 54 passes radially outwardly through the predetermined gap 12 between the first cutting edge 10 and the cutting head 4. The slices 54 fly radially outwardly from the cutting head 4 and are collected in known manner for subsequent processing, for example frying and seasoning to form potato chips.

The second cutting edge 36 longitudinally cuts any potato slice 54 having a width greater than the predetermined distance D into two slice portions 50, 52. The two slice portions 50, 52 comprise a first slice portion 50 having a first maximum width W1 corresponding to the predetermined distance D and a second slice portion 52 having a second maximum width W2 smaller than the first maximum width W1. Since only one second cutting edge 36 is provided in each knife 8, each slice 54 having a width greater than the predetermined distance D is cut into only two slice portions 50, 52.

The cutting into slices 54 by the first cutting edge 10 and the cutting of the slices 54 into two slice portions 50, 52 by the second cutting edge 36 are carried out substantially simultaneously.

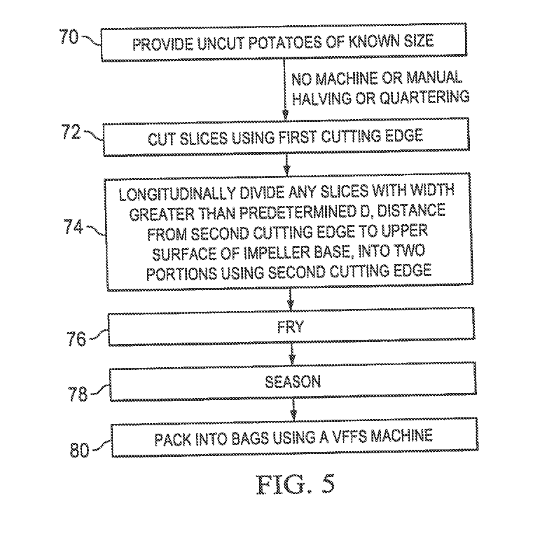

Referring to FIG. 5, in the method of the invention a plurality of uncut potatoes is provided in step 70 which have been graded to provide a potato diameter distribution having a given median potato diameter. There is no machine or manual halving or quartering of the whole potatoes. The uncut potatoes are fed to the cutting head adapted to cut the potatoes into slices in step 72. In the cutting head, each potato is cut into a plurality of slices. Only those slices 54 having a width greater than at least the median potato diameter are additionally cut longitudinally into first and second slice portions 50, 52, as shown by step 74. After the cutting head slicing and cutting operations in steps 72 and 74, the potato slices are then fried in step 76, seasoned in step 78 and packaged into bags using a VFFS machine in step 80.

In the method of the invention, the predetermined distance D is dependent upon the dimensions of the specific population or batch of potatoes to be cut in the particular cutting operation. The aim is to set the predetermined distance D so that large potatoes can be processed by the potato chip cutting apparatus 2 to form potato slices, yet the resultant slices have a size distribution which (a) minimizes packaging losses while additionally (b) maximizing the number and proportion of slices which have been cut to form straight edges, by the cutting action of the second cutting edge 36, and (b) minimizes the number and proportion of small dimension slices. Potato chips with straight edges and an excessive number and proportion of small dimension potato chips in a package of potato chips is generally not acceptable to the consumer.

Typically, to meet this aim the plurality of potatoes initially provided for processing to form potato slices and then potato chips has a median potato diameter, and the predetermined distance D is greater than the median potato diameter. This technical relationship between the dimensions of the particular potatoes to be cut and the set-up of the potato chip cutting apparatus 2 can provide that at least 50% of the slices produced after the cutting steps of the first and second cutting edges 10, 36 are uncut. Preferably, the predetermined distance D is greater than the median potato diameter so that at least 60% of the slices produced after these cutting steps are uncut.

In the method of manufacturing potato chips of the embodiment of the invention, after the plurality of potato slices has been cut, the potato slices are cooked and seasoned to produce flavored potato chips. Thereafter, a measured amount of the potato chips is filled into a package. Typically, the package comprises a flexible bag, of selected dimensions, for packaging a defined weight of the potato chips. The bag is filed by, for example, a known vertical form, fill and seal (VFFS) machine. During the filling step, the package has an upper opening presenting a maximum width dimension, through which the potato chips are filled downwardly into the bag under gravity. In a preferred embodiment of the invention, the potato chips have a maximum width which is no more than 90% of the maximum width dimension of the opening. Typically, the potato chips have a maximum width which is no more than 80% of the maximum width dimension of the opening.

In the preferred embodiment of the invention, and referring again to FIG. 5, a plurality of uncut potatoes is provided in step 70 which have been graded to provide a potato diameter distribution having a median potato diameter. There is no machine or manual halving or quartering of the whole potatoes. The uncut potatoes are fed to the cutting head adapted to cut the potatoes into slices in step 72. In the cutting head, each potato is cut into a plurality of slices. The cutting in the cutting head is carried out so that at least 50%, more preferably at least 60%, of the slices produced after the cutting steps, are uncut. Such a slice population is provided by setting the predetermined distance D so that only those slices having a width greater than at least the median potato diameter are additionally cut longitudinally into first and second slice portions 50, 52, as shown by step 74.

In one preferred embodiment, each slice having a width greater than 70 mm is cut into first and second slice portions. In another preferred embodiment, each slice having a width greater than 60 mm is cut into first and second slice portions. In a further preferred embodiment, each slice having a width greater than 50 mm is cut into first and second slice portions. The selection of the particular predetermined distance D, for example in the embodiments above D being set at 70 mm, 60 mm or 50 mm, is typically dependent on a dimensional analysis of the potato supply to be sliced, and typically the potato supply has been pre-graded to give a particular dimensional range.

Again, the aim is to provide sufficient longitudinal division of excessively large slices to minimize packaging waste while minimizing the production of longitudinally cut or excessively small slices by setting the predetermined distance D based upon the dimensional analysis of the potato supply. This setting can be achieved on a trial and error basis following an initial short run of a small population size representative of the larger population in a typical batch for commercial processing on a potato chip production line.

In the preferred embodiments, a particular cutting head is disclosed. However, the present invention can be utilized with a wide variety of different cutting head shapes and dimensions.

In addition, in the illustrated embodiment of the invention, the cutting head is stationary and the impeller rotates within the stationary cutting head. In alternative embodiments of the invention, the cutting head also rotates, and the impeller rotates within the rotating cutting head, with the cutting head and impeller either rotating in the same rotational direction but at different rotational speeds or rotating in opposite rotational directions.

Furthermore, the present invention can be utilized with various blade shapes and configuration, and accordingly the cutting head can be used with linear planar blades, such as for manufacturing conventional potato chips, or profiled blades, such as for manufacturing crinkle cut or other three dimensionally-shaped potato chips.

The cutting head of the preferred embodiments of the invention may be of the two ring or single ring type.

The present invention will now be illustrated further with reference to the following non-limiting Example.

### Example

A potato slice cutting apparatus having the structure of FIGS. 1 to 4 was employed to cut potato slices for the manufacture of potato chips. The slices were employed to produce potato chips according to the process flow chart of FIG. 5.

The dimension D was set at 70 mm. This dimension provided that, for the incoming potato stock, at least about 60% of the resultant potato chips were “uncut” in that they had no straight cut edges around their periphery and had not been cut longitudinally by the second cutting edge, but instead had been passed beneath the second cutting edge. The potato chips were packaged into 25 gram bags using a conventional VFFS machine.

Over a significant production period the packaging waste, caused by potato chips corrupting the upper seal of the bag, was measured. The packaging waste was found to be reduced by at least about 0.5% as compared to two parallel potato chip production lines which had the same incoming potato stock and the same production and packaging machines except that the blades of the potato slice cutting head were conventional linear blades and no second cutting edge was provided.

For a large potato chip manufacturing oration, this 0.5% saving in packaging waste corresponds to millions of dollars in annual savings in production costs.

Other modifications to the potato slice cutting device of the preferred embodiments of the present invention will be readily apparent to those skilled in the art.

What is claimed is:

1. An apparatus for cutting potato slices, the apparatus comprising an annular-shaped cutting head and a central impeller coaxially mounted for rotation within the cutting head for delivering potatoes radially outwardly toward the cutting head, the impeller having a base with an upper surface across which potatoes are, in use, delivered to the cutting head, a plurality of knives serially mounted annularly around the cutting head, each knife having a first cutting edge extending substantially vertically and spaced from the cutting head to provide a gap, extending in a radial direction, between the first cutting edge and the cutting head, each knife also having a second cutting edge extending substantially horizontally and extending radially at least partly across the gap, the second cutting edge being located at least 50 mm above the upper surface of the impeller to define a cutting zone for cutting a single potato slice between the upper surface of the impeller and the second cutting edge.

2. The apparatus according to claim 1 wherein the second cutting edge is located from 60 mm to 90 mm above the upper surface of the impeller.

3. The apparatus according to claim 2 wherein the second cutting edge is located from 70 mm to 80 mm above the upper surface of the impeller.

4. The apparatus according to claim 1 wherein the second cutting edge is orthogonal to the first cutting edge.

5. The apparatus according to claim 1 wherein the second cutting edge is located rearwardly of the first cutting edge.

6. The apparatus according to claim 5 wherein the second cutting edge is located rearwardly of the first cutting edge by a distance of at least 1 mm.

7. The apparatus according to claim 1 wherein in each knife the first and second cutting edges are formed on respective first and second knife elements.

8. The apparatus according to claim 7 wherein the first knife element comprises an elongate substantially planar blade removably clamped to the cutting head by an elongate clamping member mounted adjacent to the first knife element.

9. The apparatus according to claim 8 wherein the second knife element comprises a blade portion extending substantially orthogonally from a base portion, the base portion being removably clamped to the cutting head by the elongate clamping member.

10. The apparatus according to claim 9 wherein the base portion is removably clamped against the first knife element.

11. The apparatus according to claim 9 wherein the elongate clamping member includes a slot through which extends the blade portion of the second knife element.

12. The apparatus according to claim 11 wherein the slot is a closed slot located rearwardly of a leading edge of the elongate clamping member.

13. The apparatus according to claim 11 wherein the elongate clamping member includes at least two slots spaced apart in a longitudinal direction along the elongate clamping member, each slot being provided for mounting the second knife element at a respective predetermined distance from the upper surface of the impeller.

14. A method of producing potato slices for the manufacture of potato chips, the method comprising the steps of:
a. providing a plurality of potatoes;
b. feeding the potatoes to a cutting head adapted to cut the potatoes into slices, the cutting head having a plurality of knives;
c. delivering each potato to a respective knife in the cutting head, the knife having a first cutting edge adapted to cut the potato into slices and a second cutting edge adapted to cut any potato slice having a width greater than a predetermined dimension into two slice portions, the two slice portions comprising a first slice portion having a first maximum width corresponding to the predetermined dimension and a second slice portion having a second maximum width smaller than the first maximum width;
d. cutting each potato into a plurality of slices by the first cutting edge; and
e. cutting each slice having a width greater than the predetermined dimension into the first and second slice portions by the second cutting edge.

15. The method according to claim 14 wherein in step b the potatoes fed to the cutting head are initially uncut.

16. The method according to claim 14 wherein the predetermined dimension is at least 50 mm.

17. The method according to claim 16 wherein the predetermined dimension is from 60 mm to 90 mm.

18. The method according to claim 17 wherein the predetermined dimension is from 70 mm to 80 mm.

19. The method according to claim 14 wherein cutting steps d and e are carried out substantially simultaneously.

20. The method according to claim 14 wherein cutting step e cuts the slice into only two slice portions.

21. The method according to claim 14 wherein the plurality of potatoes provided in step a has a median potato diameter and the predetermined distance is greater than the median potato diameter so that at least 50% of the slices produced after cutting steps d and e are uncut.

22. The method according to claim 21 wherein the predetermined distance is greater than the median potato diameter so that at least 60% of the slices produced after cutting steps d and e are uncut.

23. The method of claim 14 wherein the cutting head is an annular-shaped cutting head and a central impeller is coaxially mounted for rotation within the cutting head for delivering potatoes radially outwardly toward the cutting head.

24. The method of claim 23 wherein the impeller has a base with an upper surface across which potatoes are, in use, delivered to the cutting head, and the knives are serially mounted annularly around the cutting head.

25. The method of claim 24 wherein each first cutting edge extends substantially vertically and is spaced from the cutting head to provide a gap, extending in a radial direction, between the first cutting edge and the cutting head, each second cutting edge extending substantially horizontally and extending radially at least partly across the gap.

26. The method of claim 25 wherein each second cutting edge is located at least 50 mm above the upper surface of the impeller to define a cutting zone for cutting a single potato slice between the upper surface of the impeller and the second cutting edge.

27. A method of manufacturing potato chips, the method comprising the steps of:
i. providing a plurality of potato slices produced by the method of claim 14;
ii. cooking and seasoning the potato slices to produce flavored potato chips; and
iii. filling a measured amount of the potato chips into a package, wherein during the filling step the package has an opening presenting a maximum width dimension, and the potato chips have a maximum width which is no more than 90% of the maximum width dimension of the opening.

28. The method according to claim 23 wherein the potato chips have a maximum width which is no more than 80% of the maximum width dimension of the opening.

29. A method of manufacturing potato chips, the method including the steps of:
a. providing a plurality of uncut potatoes which have been graded to provide a potato diameter distribution having a median potato diameter;
b. feeding the uncut potatoes to a cutting head adapted to cut the potatoes into slices;
c. in the cutting head cutting each potato into a plurality of slices; and
d. in the cutting head cutting each slice having a width greater than at least the median potato diameter into first and second slice portions so that at least 50% of the slices produced after cutting steps c and d are uncut.

30. The method according to claim 29 wherein cutting steps c and d are carried out so that at least 60% of the slices produced after cutting steps c and d are uncut.

31. The method according to claim 29 wherein in cutting step d each slice having a width greater than 70 mm is cut into first and second slice portions.

32. The method according to claim 31 wherein in cutting step d each slice having a width greater than 60 mm is cut into first and second slice portions.

33. The method according to claim 32 wherein in cutting step d each slice having a width greater than 50 mm is cut into first and second slice portions.

34. The method according to claim 29 wherein cutting steps c and d are carried out substantially simultaneously.

35. The method according to claim 29 wherein cutting step d cuts the slice into only two slice portions.

36. The method of claim 29 wherein the cutting head is an annular-shaped cutting head and a central impeller is coaxially mounted for rotation within the cutting head for delivering potatoes radially outwardly toward the cutting head.

37. The method of claim 36 wherein the impeller has a base with an upper surface across which potatoes are, in use, delivered to the cutting head.

38. The method of claim 36 wherein the cutting head has a plurality of knives serially mounted annularly around the cutting head, each knife having a first cutting edge cutting the slices in step c and a second cutting edge cutting the slices in step d.

39. The method of claim 38 wherein each first cutting edge extends substantially vertically and is spaced from the cutting head to provide a gap, extending in a radial direction, between the first cutting edge and the cutting head, each second cutting edge extending substantially horizontally and extending radially at least partly across the gap.

40. The method of claim 39 wherein each second cutting edge is located at least 50 mm above the upper surface of the impeller to define a cutting zone for cutting a single potato slice between the upper surface of the impeller and the second cutting edge.

41. The method according to claim 29, the method further comprising the step of:
e. cooking and seasoning the potato slices from cutting steps c and d to produce flavored potato chips; and
f. filling a measured amount of the potato chips into a package, wherein during the filling step the package has an opening presenting a maximum width dimension, and the potato chips have a maximum width which is no more than 90% of the maximum width dimension of the opening.

42. The method according to claim 41 wherein the potato chips have a maximum width which is no more than 80% of the maximum width dimension of the opening.

43. The apparatus according to claim 6 wherein the second cutting edge is located rearwardly of the first cutting edge by a distance of 4 to 10 mm.
